(19) United States
(12) Patent Application Publication
(10) Pub. No.: US 2025/0164681 A1
(43) Pub. Date: May 22, 2025

(54) A LASER-BASED OPTICAL SYSTEM

(71) Applicant: SIGNIFY HOLDING B.V., EINDHOVEN (NL)

(72) Inventors: HUGO JOHAN CORNELISSEN, ESCHAREN (NL); TIES VAN BOMMEL, HORST (NL); OXEXANDR VALENTYNOVYCH VDOVIN, MAARHEEZE (NL); RIFAT ATA MUSTAFA HIKMET, EINDHOVEN (NL)

(21) Appl. No.: 18/874,748

(22) PCT Filed: Jun. 19, 2023
(86) PCT No.: PCT/EP2023/066377

§ 371 Date: Dec. 13, 2024

(30) Foreign Application Priority Data
Jun. 21, 2022 (EP) 22180064.2

(51) Int. Cl. F21V 8/00; H05B 47/155

(52) U.S. Cl. CPC G02B 6/0008; H05B 47/155

(57) ABSTRACT

An optical system (1) configured to guide laser light and comprising a plurality of optical fibers, each optical fiber (3-11) of the plurality of optical fibers comprising a longitudinal axis (L), a first end (12) forming a light entry facet, a second end (15), a first section (13) and a second section (14), the first section (13) extending in a direction parallel with the longitudinal axis (L) from the first end (12) to the second section (14), and the second section (14) extending in a direction parallel with the longitudinal axis (L) from the first section (13) to the second end (15), the first section (13) comprising a first cross-section, the first cross-section comprising a first cross-sectional area being constant in a direction parallel with the longitudinal axis (L), at least one of the second end (15) and at least a part (17) of an outer surface (141) of the second section (14) forming a light exit facet, and the second section (14) comprising a second cross-section, the second cross-section comprising a second cross-sectional area, the second cross-sectional area decreasing in a direction parallel with the longitudinal axis (L) from the first section (13) towards the second end (15), the plurality of optical fibers (3-11) being arranged in an array (2) of optical fibers, the array (2) comprising n*m optical fibers, n and m being integers, and at least one of n and m being two or more.

### FIELD OF THE INVENTION

The invention relates to a lamp or a luminaire comprising a laser-based optical system, or an optical system configured to guide laser light, the optical system comprising a plurality of optical fibers, each optical fiber of the plurality of optical fibers comprising a longitudinal axis, a first end forming a light entry facet, a second end, a first section and a second section.

### BACKGROUND OF THE INVENTION

In laser-based lighting, it is well known that light can be transported and delivered by optical fibers. At the end of the fibers, lenses or reflectors are required for beam shaping and color mixing. These elements add considerably to the size of the lighting system.

Commercially available fiber combiners, where a fixed number of input fibers is fused together into one, are known in the art. The number of fibers is fixed, e.g., to three or four, and cannot be changed. If it is desired to combine more or less fibers, a new combiner needs to be installed.

WO 97/34175 A1 discloses a fiber optic probe assembly for low light spectrographic analysis which improves response to subtle light-matter interactions of high analytical importance and reduces sensitivity to otherwise dominant effects. This fiber optic probe assembly comprises a central fiber having a flat end face at its distal end and a plurality of fibers surrounding the central fiber and having a shaped end face at their distal ends. The plurality of fibers are parallel to the central fiber at their distal ends and the shaped end faces provide an internally reflective surface for steering the fields of view associated with the plurality of fibers toward the central fiber. The fibers also incorporate filters, cross-talk inhibitors and other features that provide a high performance probe in a robust package. Design variations provide side viewing, viewing through a common aperture, viewing along a common axis, and other features.

JP-A-S56119108 discloses the use of a laser light source and an optical fiber bundle for printing in order to increase the speed of printing.

Kosterin, Andrey, e.a., Tapered fiber bundles for combining high-power diode lasers, Applied Optics, vol. 43, No. 19, July 2004, discloses the use of tapered fiber bundles to combine the output power of several semiconductor lasers into an optical fiber in order to increase the brightness.

US-B1-9063289 discloses tapered couplers that include a plurality of optical fibers in order to increase the brightness. The tapering is the result of fibers fused in a fused and tapered region.

US-A1-2021/0263217 discloses an optical coupler array for coupling a plurality of fibers to an optical device for telecommunication in order to improve optical coupling between a set of isolated fibers.

CN-B_109621098 discloses a system for measuring space light radiation using an optical fiber transmission bundle.

It is desired to provide a laser-based optical system being more compact and comprising a smaller number of optical components.

### SUMMARY OF THE INVENTION

It is an object of the present invention to overcome this problem, and to provide a lamp or a luminaire comprising a laser-based optical system being more compact and comprising a smaller number of optical components.

According to a first aspect of the invention, this and other objects are achieved by means of a lamp or a luminaire comprising an optical system configured to guide laser light, the optical system comprising a plurality of optical fibers, each optical fiber of the plurality of optical fibers comprising a longitudinal axis, a first end forming a light entry facet, a second end, a first section and a second section, the first section extending in a direction (substantially) parallel with the longitudinal axis from the first end to the second section, and the second section extending in a direction (substantially) parallel with the longitudinal axis from the first section to the second end, the first section comprising a first cross-section, the first cross-section comprising a first cross-sectional area being (substantially) constant in a direction parallel with the longitudinal axis, at least one of the second end and at least a part of an outer surface of the second section forming a light exit facet, and the second section comprising a second cross-section, the second cross-section comprising a second cross-sectional area, the second cross-sectional area decreasing in a direction parallel with the longitudinal extension from the first section towards the second end, where the plurality of optical fibers are arranged in an array of optical fibers, the array comprising n*m optical fibers, n and m being integers, and at least one of n and m being two or more.

The second section of each optical fiber is thus in essence tapered or conical. When using optical fibers of the type described above, and particularly when arranging such optical fibers in an array of optical fibers, the array comprising n*m optical fibers, wherein n and m are integers, and wherein at least one of n and m is two or more, the obtained fiber bundle does not need to be fused because the second ends have a reduced size which already fit in a small area.

Thereby it becomes possible to easily replace a defect fiber by another one and to easily add or remove a fiber from the bundle, both of which is not possible with a conventional fused combiner. It further becomes possible to combine different angular emissions from different fibers, for instance to compensate for angular color differences, or for aesthetic reasons.

In other words, such an optical system offers greater customization possibilities for the luminaire maker. Furthermore, such an optical system is much simpler to dismantle and separate for recycling purposes and is therefore more apt for a cyclic economy.

Furthermore, using optical fibers of the type described above and arranging them in an array, provides for an optical system configured to guide laser light with which separate optical elements, such as lenses or reflectors, required for beam shaping and color mixing is no longer necessary. Thus, such an optical system is more compact and requires a smaller number of optical components since no optical elements apart from the tapered optical fibers are necessary.

In an embodiment, at least one of n and m is at least three, at least six or at least nine.

In principle, the integers n and m may be chosen to be any desired integer. Thereby, laser-based optical systems with any desired number of optical fibers in the array of optical fibers may be obtained. Thereby a wide degree of freedom in design and construction of the laser-based optical system is enabled.

In an embodiment, at least a part of an outer surface of the second section adjacent to the second end forms at least a part of the light exit facet.

Thereby, not only an improved color mixing, but also an improved exit beam broadening is achieved.

In an embodiment, the second section comprises a tapering angle, β, defined as the angle between a longitudinal center axis of the second section and an outer surface of the second section, where the tapering angle, β, is less than 2 degrees.

In an embodiment, the second section extends over between 65% and 90% of the total longitudinal extension of the at least one optical fiber.

In an embodiment, the cross-sectional area at the second end is less than 10% of the cross-sectional area at the first end.

Thereby, tapered optical fibers with a pointed or sharp second end is achieved. Such optical fibers provide for an optical system configured to guide laser light with which a high degree of broadening of the exit light beam and/or complex far field light patterns or intensity patterns may be obtained.

In an embodiment, the second section comprises a tapering angle, β, defined as the angle between a longitudinal center axis of the second section and an outer surface of the second section, where the tapering angle, β, is between 2 and 6 degrees.

In an embodiment, the second section extends over between 35% and 65% of the total longitudinal extension of the at least one optical fiber.

In an embodiment, the cross-sectional area at the second end is less than 25% of the cross-sectional area at the first end.

Thereby, tapered optical fibers with a second end having a small surface area is achieved. Such optical fibers provide for an optical system configured to guide laser light with which the degree of broadening of the exit light beam obtained is high while the obtained far field light patterns or intensity patterns are less complex.

In an embodiment, the second section comprises a tapering angle, β, defined as the angle between a longitudinal center axis of the second section and the periphery of a circle circumscribing an outer surface of the second section, where the tapering angle, β, is between 6 degrees and 15 degrees.

In an embodiment, the second section extends over between 1% and 35% of the total longitudinal extension of the at least one optical fiber.

In an embodiment, the cross-sectional area at the second end is less than 50% of the cross-sectional area at the first end.

Thereby, tapered optical fibers with a second end having a small surface area is achieved. Such optical fibers provide for an optical system configured to guide laser light with which the exit light beam is only broadened to a relatively limited degree while the obtained far field light patterns or intensity patterns are homogenous and well defined.

Thus, it is generally possible, by adjusting the geometrical parameters of the optical fibers, and in particular the tapering angle, β, to obtain a far field light pattern or intensity pattern suitable and desired for a specific purpose.

In an embodiment, the second end is any one of blunt and pointed or point-shaped.

In an embodiment, the second section is any one of tapered, conical and frustoconical.

A blunt second end or a frustoconical second section enables obtaining far field light patterns or intensity patterns which are homogenous and well defined.

A pointed or point-shaped second end or a tapered or conical second section enables obtaining far field light patterns or intensity patterns of more complex structures as well as a further broadening of the light beam.

In an embodiment, the first section is configured to mix light propagating therethrough.

Thereby, improved color mixing is obtained without the need for any additional optical components.

In an embodiment, the second section is configured to broaden the angular spread of the light propagating therethrough. The second section is also configured to out-couple the light propagating therethrough.

Thereby, improved exit beam broadening is obtained without the need for any additional optical components.

In an embodiment, the optical fibers of the array of optical fibers all comprise a cross-section of the same shape.

In an embodiment, at least one optical fiber of the array of optical fibers comprises a cross-section having a first shape, and the remaining optical fibers of the array of optical fibers comprise a cross-section having a second shape being different from the first shape.

Thereby, a further parameter suitable for adjusting the geometrical parameters of the optical fibers, and in particular the tapering angle, β, to obtain a far field light pattern or intensity pattern suitable and desired for a specific purpose is provided.

In an embodiment, the cross-sectional shape of each optical fiber of the array of optical fibers perpendicular to the longitudinal extension is any one of square, rectangular, octagonal, circular and hexagonal.

Optical fibers with a cross-sectional shape being square rectangular, octagonal, or hexagonal have the advantage that the tapered ends may be stacked very densely, without any gaps. This in turn provides for an even more compact laser-based optical device.

Optical fibers with a cross-sectional shape being circular have the advantage of being particularly simple to manufacture, while still providing for a compact laser-based optical device.

In an embodiment, at least one optical fiber of the array of optical fibers further comprises a mirror or a rotatable mirror arranged at the light exit facet.

In an embodiment, the array of optical fibers further comprises a monolithic mirror element arranged at the light exit facets of the optical fibers of the array of optical fibers.

Providing, a mirror, a rotatable mirror or a monolithic mirror element provides the advantage of enabling to redirect the light exiting the optical fiber or fibers.

In an embodiment, the laser-based optical system further comprises a plurality of laser light sources, each being configured to, in operation, emit a beam of laser light, at least two laser light sources of the plurality of laser light source being arranged to emit the respective beams of laser light in a direction towards the first end of the same optical fiber of the plurality of optical fibers.

Thereby, the total light output of the laser-based optical system is increased and/or the mixing of laser light of different wavelengths is improved.

The lamp or the luminaire further comprises at least one laser light source configured to, in operation, emit a beam of laser light, the at least one laser light source being arranged to emit the beam of laser light in a direction towards the first end of at least one optical fiber of the plurality of optical fibers.

The term “laser light source” especially refers to a laser. Such laser may especially be configured to generate laser light source light having one or more wavelengths in the UV, visible, or infrared, especially having a wavelength selected from the spectral wavelength range of 200-2000 nm, such as 300-1500 nm. The term “laser” especially refers to a device that emits light through a process of optical amplification based on the stimulated emission of electromagnetic radiation.

Especially, in embodiments the term “laser” may refer to a solid-state laser. In specific embodiments, the terms “laser” or “laser light source”, or similar terms, refer to a laser diode (or diode laser).

In embodiments, the terms “laser light source” or “solid state laser” may refer to one or more of cerium doped lithium strontium (or calcium) aluminum fluoride (Ce:LiSAF, Ce:LiCAF), chromium doped chrysoberyl (alexandrite) laser, chromium ZnSe (Cr:ZnSe) laser, divalent samarium doped calcium fluoride (Sm:CaF2) laser, Er:YAG laser, erbium doped and erbium-ytterbium codoped glass lasers, F-Center laser, holmium YAG (Ho:YAG) laser, Nd:YAG laser, NdCrYAG laser, neodymium doped yttrium calcium oxoborate Nd:YCa₄O(BO3)3 or Nd:YCOB, neodymium doped yttrium orthovanadate (Nd:YVO4) laser, neodymium glass (Nd:glass) laser, neodymium YLF (Nd:YLF) solid-state laser, promethium 147 doped phosphate glass (147Pm3+:glass) solid-state laser, ruby laser (Al2O3:Cr3+), thulium YAG (Tm:YAG) laser, titanium sapphire (Ti:sapphire; Al2O₃:Ti3+) laser, trivalent uranium doped calcium fluoride (U:CaF2) solid-state laser, Ytterbium doped glass laser (rod, plate/chip, and fiber), Ytterbium YAG (Yb:YAG) laser, Yb2O3 (glass or ceramics) laser, etc.

In embodiments, the terms “laser light source” or “solid state laser” may refer to one or more of a semiconductor laser diode, such as GaN, InGaN, AlGaInP, AlGaAs, InGaAsP, lead salt, vertical cavity surface emitting laser (VCSEL), quantum cascade laser, hybrid silicon laser, etc.

In an embodiment, the optical system further comprises an optical fiber arranged to guide the beam of laser light from the at least one laser light source to the first end of at least one optical fiber of the plurality of optical fibers.

Thereby, the amount of light lost between the at least one laser light source and the optical fiber is minimized or eliminated altogether.

The lamp or the luminaire further comprises a controller configured for controlling or individually controlling one more laser light source of the at least one laser light source.

In an embodiment, the lamp or the luminaire comprises a plurality of laser light sources (19), each being configured to, in operation, emit a beam of laser light, at least two laser light sources of the plurality of laser light source being arranged to emit the respective beams of laser light in a direction towards the first end of the same optical fiber of the plurality of optical fibers.

In an embodiment, the controller is configured for individually controlling each of the plurality of laser light sources.

It is noted that the invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention.

FIG. 1 shows a perspective view of an optical system configured to guide laser light according to a first embodiment of the invention.

FIG. 2 shows a cross-sectional side view of an optical system according to FIG. 1.

FIG. 3 shows a perspective view of an optical system according to a second embodiment of the invention each optical fiber having a blunt second end.

FIG. 4 shows a cross-sectional side view of an optical system similar to that of FIG. 3, but where each optical fiber has a sharp or pointed second end.

FIG. 5 shows a perspective view of an optical system according to a third embodiment of the invention, each optical fiber having a blunt second end.

FIG. 6 shows a cross-sectional side view of an optical system similar to that of FIG. 5, but where each optical fiber has a sharp or pointed second end.

FIG. 7 shows a cross-sectional side view of an optical system according to a fourth embodiment of the invention.

FIG. 8 shows a perspective view of three optical fibers which may form part of an optical system according to the invention, the three optical fibers having mutually different cross-sectional shapes.

FIG. 9 shows a cross-sectional side view of the three optical fibers according to FIG. 8.

FIG. 10 shows a cross-sectional side view of an exemplary optical fiber of an optical system according to the invention illustrating various geometrical properties of such an optical fiber.

FIG. 11 shows a collection of in total fifteen simulation results, in each of which 9 laser light beams, three red, three green and three blue, are transported via standard optical fibers (not shown) and subsequently coupled into an optical system according to the invention comprising an array of 3*3 fibers with a square cross-sectional shape. For each simulation result, the light pattern at a distance of 50 mm from the second end (left) as well as the far field intensity distribution (right) is shown. The top row shows simulation results for an array of 3*3 fibers according to FIG. 1. The center row shows simulation results for an array of 3*3 fibers according to FIG. 2. The bottom row shows simulation results for an array of 3*3 fibers according to FIG. 3.

FIG. 12 shows another collection of in total fifteen simulation results, in each of which 9 laser light beams, three red, three green and three blue, are transported via standard optical fibers (not shown) and subsequently coupled into a laser-based optical system according to the invention comprising an array of 3*3 fibers. For each simulation result, the light pattern at a distance of 50 mm from the second end (left) as well as the far field intensity distribution (right) is shown. The top row shows simulation results for an array of 3*3 fibers with a circular cross-sectional shape. The center row shows simulation results for an array of 3*3 fibers with a hexagonal cross-sectional shape. The bottom row shows simulation results for an array of 3*3 fibers with a square cross-sectional shape.

FIGS. 13A-C shows yet another simulation result. FIG. 13A illustrates the embodiment of an optical system according to the invention on which the simulation results were obtained. FIG. 13B shows the effect of the first section and the second section of each optical fiber. FIG. 13C shows a plot of the simulated far field intensity distribution.

FIG. 14 schematically depicts embodiments of a luminaire and a lamp.

As illustrated in the figures, the sizes of layers and regions are exaggerated for illustrative purposes and, thus, are provided to illustrate the general structures of embodiments of the present invention. Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

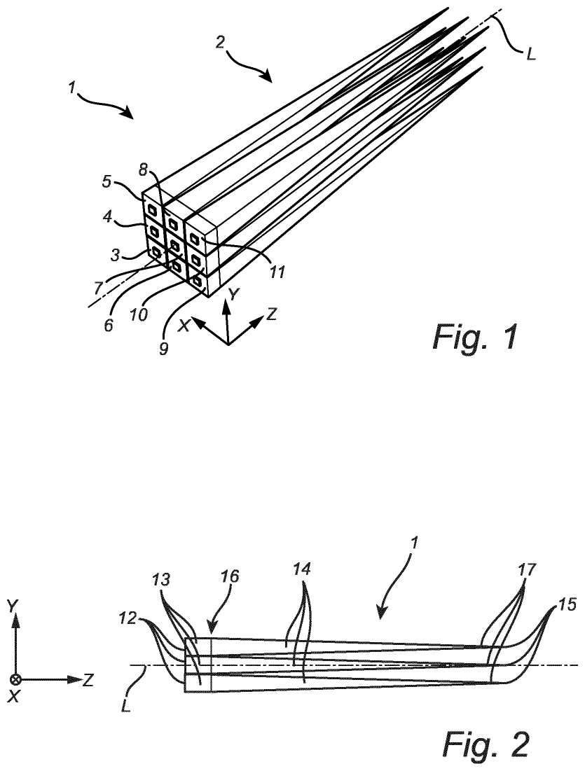

FIG. 1 shows a perspective view of an optical system 1 configured to guide laser light, in the following also denoted a laser-based optical system 1, according to a first embodiment of the invention. FIG. 2 shows a cross-sectional side view of the laser-based optical system 1 according to FIG. 1.

Generally, and irrespective of the embodiment, the laser-based optical system 1 comprises a plurality of optical fibers 3-11. The plurality of optical fibers 3-11 are arranged in an array 2 of optical fibers. The array 2 generally comprises n*m optical fibers, n and m being integers, and at least one of n and m being two or more. In the embodiment shown in FIG. 1, the array 2 is a 3*3 array with a total of nine optical fibers 3, 4, 5, 6, 7, 8, 9, 10, 11. However, the integers n and m may be chosen to have any value suitable for providing an array of a desired size. For instance, one or both of n and m may be at least three, at least six or at least nine.

Referring to FIG. 2, generally, and irrespective of the embodiment, each optical fiber 3-11 of the array 2 of optical fibers comprises a longitudinal axis L, a first end 12, a second end 15, a first section 13 and a second section 14. As shown on FIGS. 1 and 2, referring to the inserted coordinate system, the longitudinal axis L extends in the Z-direction.

The first end 12 forms a light entry facet for coupling laser light 20a, 20b, 20c from a laser light source 19 into each the optical fibers 3-11. For simplicity the laser light sources 19 and the laser light 20a, 20b, 20c is not shown in FIGS. 1 and 2. See instead FIG. 7.

The first section 13 extends in a direction parallel with the longitudinal axis L from the first end 12 or light entry facet to the second section 14. The first section 13 is configured to mix laser light coupled into the fiber and propagating through the first section 13. The first section 13 comprises a first cross-section. As shown on FIGS. 1 and 2, referring to the inserted coordinate system, the first cross-section extends in the XY-plane, and thus perpendicular to the longitudinal direction L. The first cross-section comprises a first diameter D1 (cf. FIG. 10) and a first cross-sectional area. The first cross-sectional area is constant in a direction parallel with the longitudinal axis L.

The second section 14 extends in a direction parallel with the longitudinal axis L from the first section 12 to the second end 15. The first section 13 and the second section 14 extend in extension of each other. The second section 14 is configured to broaden the angular spread of the mixed light, that is light having propagated through the first section 13, propagating through the second section 14. The second section 14 is further configured to couple out light propagating through the second section 14, especially at or through the second end 15. The second section 14 comprises a second cross-section. As shown on FIGS. 1 and 2, referring to the inserted coordinate system, the second cross-section extends in the XY-plane, and thus perpendicular to the longitudinal direction L. The second cross-section comprises a second cross-sectional area and a second diameter D2 (cf. FIG. 10). The second cross-sectional area of the second cross-section decreases in a direction parallel with the longitudinal axis L from the first section 13 towards the second end 15. Thus, the second cross-sectional area of the second cross-section is largest at the first section 13 and smallest at the second end 15. In the embodiment shown on FIGS. 1 and 2 the second end 15 is pointed or even point-shaped. The second section 14 is either tapered, conical or frustoconical.

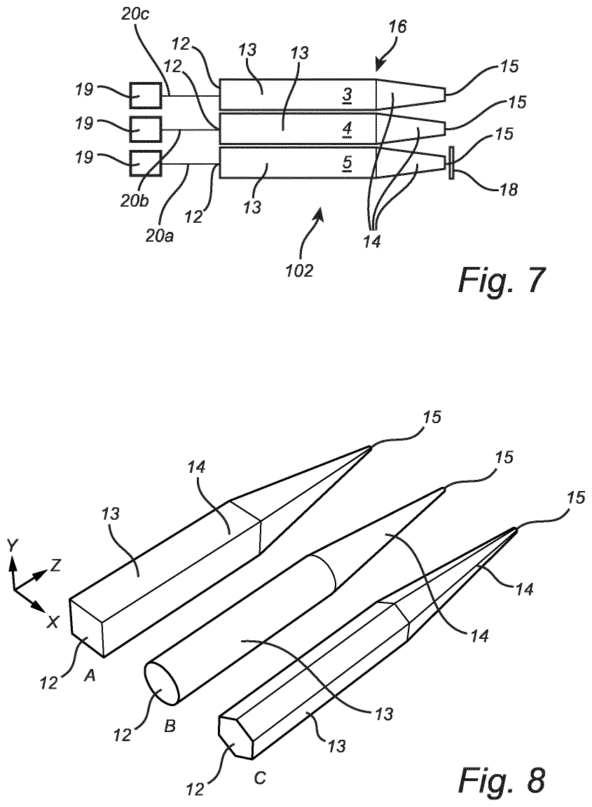

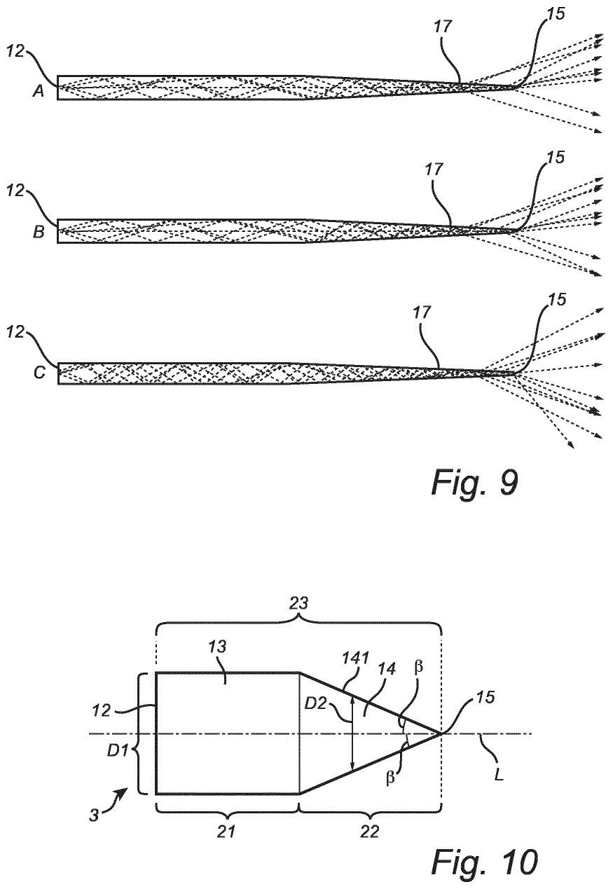

At least one of the second end 15 and at least a part 17 (FIG. 8) of an outer surface of the second section 14 forms a light exit facet through which light having propagated through the optical fiber is coupled out of the optical fiber. In the embodiment shown on FIGS. 1 and 2 it is mainly a part 17 of an outer surface of the second section 14 adjacent to the second end 15 that forms the light exit facet through which light having propagated through the optical fiber is coupled out of the optical fiber.

By way of an example, the geometrical construction of each of the optical fibers 3-11 may also be described as follows. Each of the optical fibers 3-11 have a first end 12 or entrance facet. For instance, the first end 12 measures 1×1 mm. The first end 12 is arranged at a position Z=0 mm. A first section 13 with a straight un-tapered cross section extends from Z=0 mm to a position Z=Z_cone mm corresponding in the Figures to the transition 16 between the first section 13 and the second section 14. The first section 13 acts as a mixing portion to homogenize laser light that is injected at Z=0 mm. Then at Z=Z_cone the tapering second section 14 starts and extends until a position Z=Z_end. The second end 15 is arranged at the position Z_end. The total length of the optical fiber may for instance be 20 mm, such that Z_end is 20 mm. At the position Z_end the cross section of each optical fiber has dimensions (X_end, Y_end).

For instance, when the total length of the optical fiber is 20 mm, that is Z_end=20 mm, and Z_cone=2 mm, the second section 14 of the optical fiber is long and sharp with the second end 15 being a pointed end. This is the case for the embodiment shown in FIGS. 1 and 2.

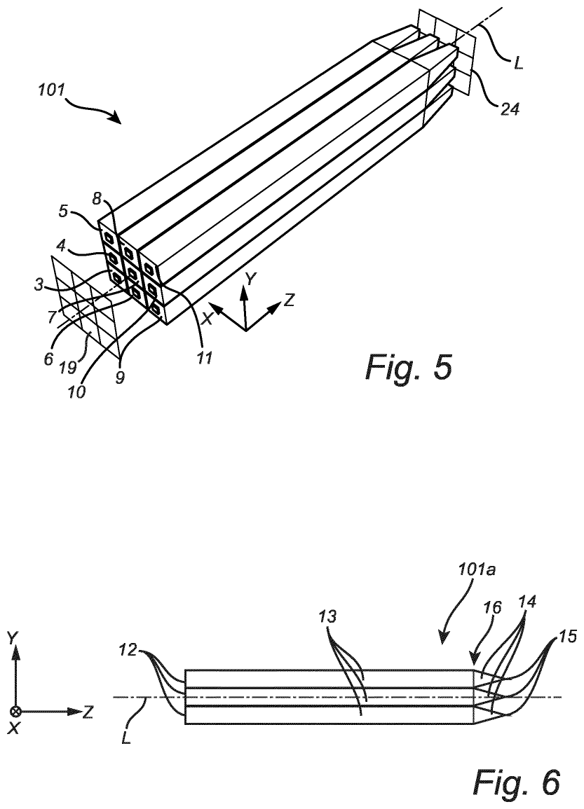

If instead Z_cone=18 mm, the second section 14 of the optical fiber is short and the second end 15 may be either of a blunt end (cf. the laser-based optical systems 101 and 102 according to the third and fourth embodiments shown in FIGS. 5 and 7, respectively) and a sharp end (cf. the laser-based optical system 101a according to the modified third embodiment shown in FIG. 6).

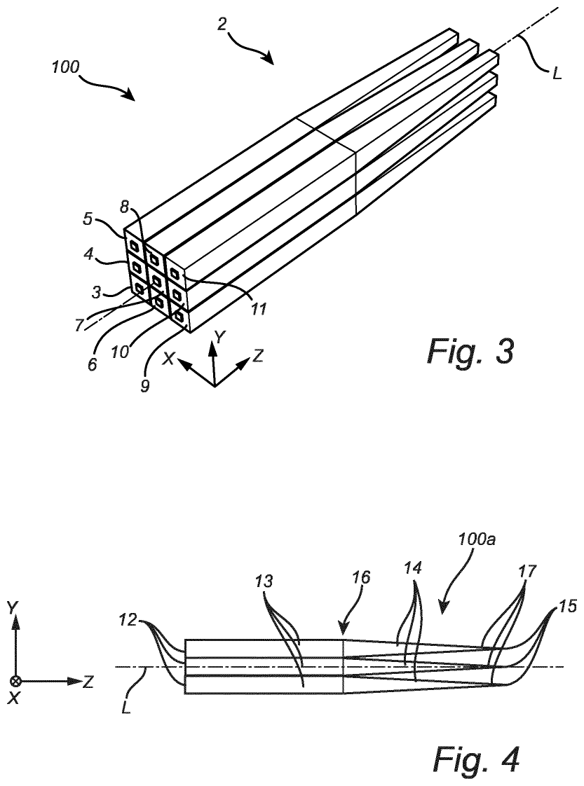

Finally, if instead Z_cone=10 mm, the second section 14 of the optical fiber is of a medium length and the second end 15 may be either of a blunt end (cf. the laser-based optical system 100 according to the second embodiment shown in FIG. 3) a sharp end (cf. the laser-based optical system 100a according to the modified second embodiment shown in FIG. 4).

Generally, the length of the second section 14 as well as whether the second end 15 is blunt or sharp may be chosen to fit with a desired use or purpose of the resulting laser-based optical system 1, 100, 101, 102.

Referring to FIG. 7, a laser-based optical system 102 according to a fourth embodiment of the invention is shown. In this embodiment, the laser-based optical system 102 further comprises a mirror 18 or a rotatable mirror arranged at the light exit facet or second end 15 of at least one optical fiber 5 of the array of optical fibers. Referring to FIG. 5, it is also feasible that all optical fibers 3-11 of the laser-based optical system 101 are provided with a mirror 18 or a rotatable mirror. In such a case the mirrors or rotatable mirrors may be provided as a monolithic mirror element 24 arranged at the light exit facets or second ends 15 of the optical fibers 3-11 of the array 2 of optical fibers. Providing a mirror 18, a rotatable mirror or a monolithic mirror element enables redirecting the light exiting the optical fiber 3 or array of optical fibers in a desired direction.

The laser-based optical system may further comprise at least one laser light source 19 (cf. FIGS. 5 and 7) configured to, in operation, emit at least one beam of laser light 20a, 20b, 20c. The at least one laser light source 19 is arranged to emit the laser light into the at least one optical fiber 3-11 through the light entry facet or first end 12. As shown in FIG. 5, an array of laser light sources 19 may be provided. The laser light sources 19 may be configured to emit light of different colors, such as red, green and blue, respectively, or of the same color.

FIG. 8 shows three examples of different cross-sectional shapes of each optical fiber 3-11 of an array of optical fibers of a laser-based optical system according to the invention. Non-limiting examples of feasible cross-sectional shapes are square (FIG. 8A), circular (FIG. 8B), hexagonal (FIG. 8C), rectangular and octagonal. The cross-sectional shape of each optical fiber 3-11 is the same along the whole length of the optical fiber. That is, the first section 13 and the second section 14 comprise the same cross-sectional shape. The optical fibers 3-11 of the array of optical fibers may all comprise the same cross-sectional shape. Alternatively, at least one optical fiber 3-11 of the array of optical fibers may comprise a cross-sectional shape differing from the cross-sectional shape of the remaining optical fibers.

Turning now to FIG. 10, a schematical cross-sectional side view of an optical fiber 3 of an array of optical fibers of a laser-based optical system according to the invention is shown. Referring to FIG. 10, further parameters of each optical fiber of an array of optical fibers of a laser-based optical system according to the invention will be described. The second section 14 comprises a tapering angle, β. The tapering angle R is defined as the angle between the longitudinal center axis L of the second section 14 and the periphery of a circle circumscribing an outer surface 141 of the second section 14. Since the optical fiber 3 shown in FIG. 3 comprises a circular cross section, the outer surface 141 of the second section 14 and the periphery of the circle circumscribing the outer surface 141 of the second section 14 are in this case coinciding. The tapering angle R may for instance be less than 2 degrees, between 2 and 6 degrees, or between 6 degrees and 15 degrees. The relation between the tapering angle R and the length 22 of the second section 14 may be chosen to determine whether or to what degree the second end 15 is sharp or blunt.

The first section 13 comprises a length 21. The second section 13 comprises a length 22. The optical fiber 3 comprises a total length 23 being the sum of the length 21 of the first section 13 and the length 22 of the second section 14. The second section 14 may for instance extend over between 1% and 35% of the total length 23 of the optical fiber 3, between 35% and 65% of the total length 23 of the one optical fiber 3, or between 65% and 90% of the total length 23 of the optical fiber 3. Also, the cross-sectional area of the optical fiber 3 at the second end 15 may be less than 50%, less than 25% or less than 10% of the cross-sectional area of the optical fiber 3 at the first end 12.

Laser-based optical systems according to the invention may be used for lighting applications such as, but not limited to, laser-based lighting in retail spots, downlights, decorative lighting and pixelated lighting.

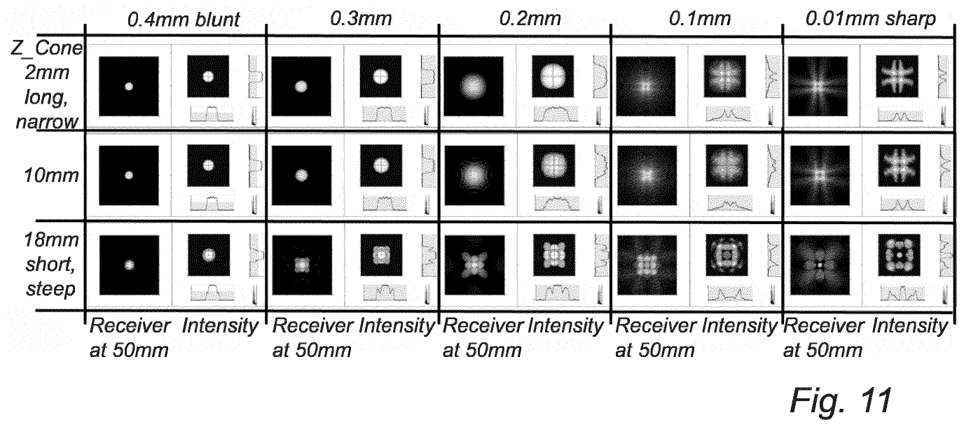

Turning now to FIGS. 11, 12 and 13, a number of examples are shown and will be described below.

### Example 1

FIG. 11 shows a collection of in total fifteen simulation results. The top row shows simulation results for a laser-based optical system according to the invention and comprising an array of 3*3 fibers according to FIG. 1. The center row shows simulation results for a laser-based optical system according to the invention and comprising an array of 3*3 fibers according to FIG. 2. The bottom row shows simulation results for a laser-based optical system according to the invention and comprising an array of 3*3 fibers according to FIG. 3. The columns show, from left to right, simulation results for fibers with a second end 15 having a size of 0.4×0.4 mm, 0.3×0.3 mm, 0.2×0.2 mm, 0.1×0.1 mm and 0.01×0.01 mm, respectively.

In each of the simulations nine laser light beams, three red, three green and three blue, or 3×(RGB), were transported via standard optical fibers (not shown) and subsequently coupled into a laser-based optical system according to the invention comprising an array of 3*3 fibers with a square cross-sectional shape. For each simulation result, the light pattern at a distance of 50 mm from the second end (left) as well as the far field intensity distribution (right) is shown.

White light results from combining the said 9 laser light beams. Each of the lasers provide a circular beam with a beam angle of 18°. The resulting output white light beam can be broadened or made square by the choice of the fiber geometry and especially the tapering angle, β. Broadening to approx. ±25°, ±350 or ±55° can for instance be obtained as shown in FIG. 11.

### Example 2

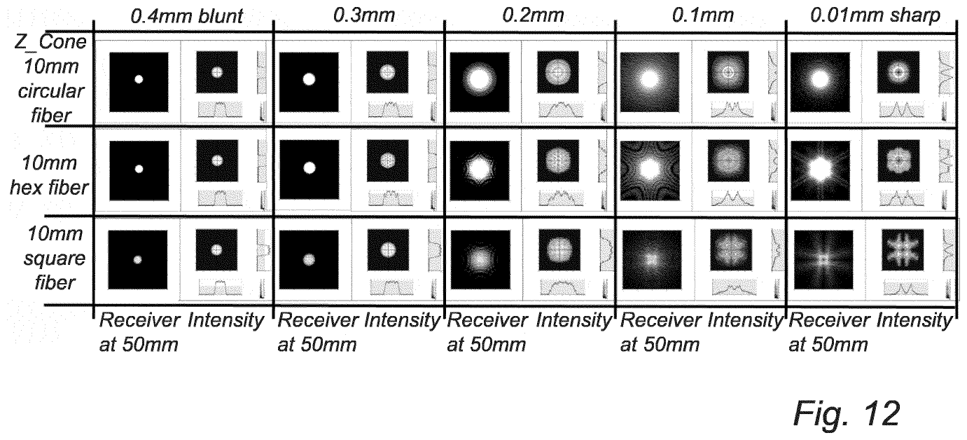

FIG. 12 shows another collection of in total fifteen simulation results. The top row shows simulation results for a laser-based optical system according to the invention and comprising an array of 3*3 fibers with a circular cross-sectional shape. The center row shows simulation results for a laser-based optical system according to the invention and comprising an array of 3*3 fibers with a hexagonal cross-sectional shape. The bottom row shows simulation results for a laser-based optical system according to the invention and comprising an array of 3*3 fibers with a square cross-sectional shape. FIG. 12 thus illustrates the effect of using different fiber cross sections. The columns show, from left to right, simulation results for fibers with a second end 15 having a size of 0.4×0.4 mm, 0.3×0.3 mm, 0.2×0.2 mm, 0.1×0.1 mm and 0.01×0.01 mm, respectively.

In each of the simulations, nine laser light beams, three red, three green and three blue, or 3×(RGB), were transported via standard optical fibers (not shown) and subsequently coupled into a laser-based optical system according to the invention comprising an array of 3*3 fibers. For each simulation result, the light pattern at a distance of 50 mm from the second end (left) as well as the far field intensity distribution (right) is shown.

It may be seen that an optical fiber with a circular cross-sectional shape (top row in FIG. 12) broadens the beam in a circular way. Also, a ring shaped far-field distribution results when the tapering angle R becomes smaller, corresponding to the size of the second end 15 becoming smaller and thus more and more sharp (seen from left to right in FIG. 12).

An optical fiber with a hexagonal cross-sectional shape (middle row in FIG. 12) creates a hexagonal far-field pattern that becomes more pronounced with decreasing tapering angle β, corresponding to the size of the second end 15 becoming smaller and thus more and more sharp (seen from left to right in FIG. 12).

An optical fiber with a square cross-sectional shape (bottom row in FIG. 12) firstly broadens the beam in a circular way and develops a four-fold symmetry with decreasing tapering angle β, corresponding to the size of the second end 15 becoming smaller and thus more and more sharp (seen from left to right in FIG. 12).

### Example 3

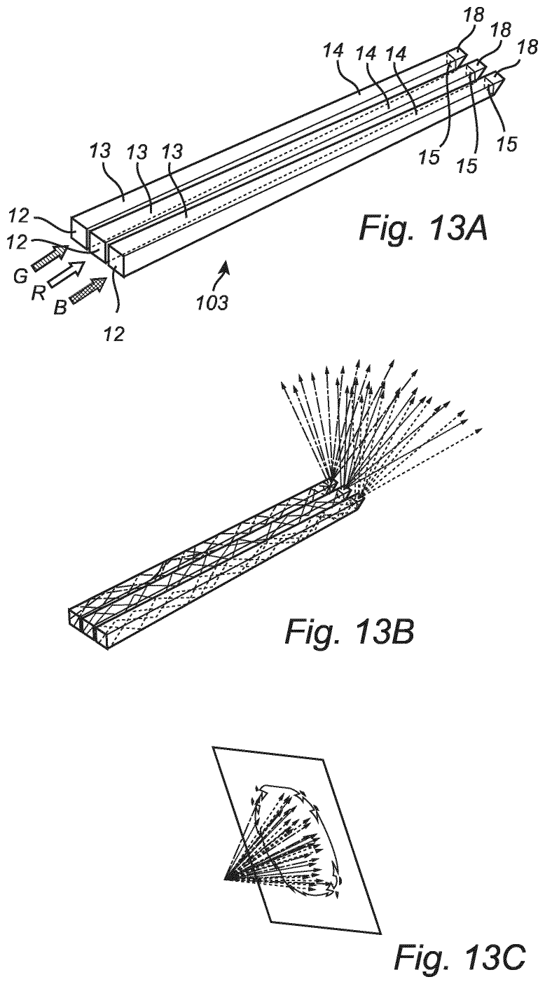

FIGS. 13A-C shows another simulation result. The simulation result is obtained on a laser-based optical system 103 according to the invention and comprising an array of 1*3 fibers-cf. FIG. 13A. The three optical fibers are placed close together, and transport red (R), green (G) and blue (B) laser light, respectively. The three optical fibers comprise a square cross-sectional shape.

The light entry facet or first end 12 of each optical fiber comprises a size of 1×1 mm. The size of the second end 15, or exit facet, of each optical fiber is 0.6×0.6 mm. The three optical fibers are placed with a center to center distance of 1.1 mm. The entrance laser light beam comprises a beam angle of 18°. A mixing section, corresponding to the respective first sections 13 of the respective optical fibers, ensures light homogeneity over the cross-section of the respective optical fiber-cf. FIG. 13B. The mixing section of each optical fiber comprises a length of 10 mm. A tapered section, corresponding to the respective second sections 14 of the respective optical fibers, broadens the beams to a desired beam diameter value. The tapered section of each optical fiber comprises a length of 10 mm.

In this example the laser-based optical system used further comprises a turning mirror 18 provided to redirect the light. Each optical fiber was provided with a turning mirror 18 arranged adjacent to the second end 15. Alternatively, the turning mirrors 18 may be combined into one monolithic mirror element 24.

Because the size of the second end 15, or light exit facet, of each optical fiber is as small as mentioned above, and the fibers are placed as closely as also mentioned above, the color mixing obtained in the far field is very good, as illustrated in FIG. 13C.

Table 1 below shows the obtained broadened beam width expressed as the Full Width at Half Maximum (FWHM) and Full Width at 10% of the Maximum (FW10M), respectively, for three different sizes of the second end 15, or exit facet, of each optical fiber of a laser-based optical system according to the invention and comprising an array of 1*3 fibers as shown in FIG. 13A.

TABLE 1

| Size of second end 15 | FWHM | FW10M |
|---|---|---|
| 0.6 × 0.6 mm | 58° | 69° |
| 0.8 × 0.8 mm | 44° | 51° |
| 1.0 × 1.0 mm | 35° | 40° |

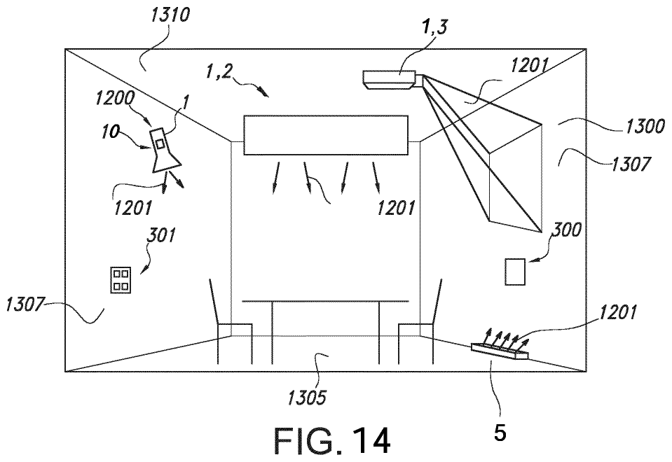

FIG. 14 schematically depicts an embodiment of a luminaire 2 comprising the optical system as described above. Reference 301 indicates a user interface which may be functionally coupled with the controller 300 comprised by or functionally coupled to the luminaire 2. The controller 300 may be configured to control the one or more laser light sources of the luminaire 2. FIG. 14 also schematically depicts an embodiment of lamp 10 comprising the optical system. The controller 300 may be configured to control the one or more laser light sources of the lamp 10. Reference 3 indicates a projector device or projector system, which may be used to project images, such as at a wall, which may also comprise optical system 1. Hence, FIG. 14 schematically depicts embodiments of a lamp 10, a luminaire 2, a projector device 3, and an optical wireless communication device 5, comprising the optical system 1 as described herein. Light escaping from the luminaire 2, the lamp 10 and the optical wireless communication device 5 is indicated with reference 1201. Reference 1300 refers to a space, such as a room. Reference 1305 refers to a floor and reference 1310 to a ceiling; reference 1307 refers to a wall.

The person skilled in the art realizes that the present invention by no means is limited to the preferred embodiments described above. On the contrary, many modifications and variations are possible within the scope of the appended claims.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%. Moreover, the terms “about” and “approximately” may also relate to 90% or higher, such as 95% or higher, especially 99% or higher, even more especially 99.5% or higher, including 100%. For numerical values it is to be understood that the terms “substantially”, “essentially”, “about”, and “approximately” may also relate to the range of 90%-110%, such as 95%-105%, especially 99%-101% of the values(s) it refers to.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A lamp or a luminaire comprising an optical system, at least one laser light source and a controller, wherein
the optical system being configured to guide laser light, the optical system comprising a plurality of optical fibers, each optical fiber of the plurality of optical fibers comprising a longitudinal axis (L), a first end forming a light entry facet, a second end, a first section and a second section,
the first section extending in a direction substantially parallel with the longitudinal axis from the first end to the second section, and the second section extending in a direction substantial parallel with the longitudinal axis from the first section to the second end,
the first section comprising a first cross-section, the first cross-section comprising a first cross-sectional area being substantially constant in a direction parallel with the longitudinal axis,
at least one of the second end and at least a part of an outer surface of the second section forming a light exit facet, and
the second section comprising a second cross-section, the second cross-section comprising a second cross-sectional area, the second cross-sectional area of the second cross-section decreasing in a direction parallel with the longitudinal extension from the first section towards the second end,
the plurality of optical fibers being arranged in an array of optical fibers, the array comprising n*m optical fibers, wherein n and m are integers, and wherein at least one of n and m is two or more,
the at least one laser light source being configured to, in operation, emit a beam of laser light, the at least one laser light source being arranged to emit the beam of laser light in a direction towards the first end of at least one optical fiber of the plurality of optical fibers,
the controller being configured for controlling or individually controlling one more laser light source of the at least one laser light source.

2. The lamp or the luminaire according to claim 1, wherein at least one of n and m is at least three, at least six or at least nine.

3. The lamp or the luminaire according to claim 1, wherein at least a part of an outer surface of the second section adjacent to the second end forms at least a part of the light exit facet.

4. The lamp or the luminaire according to claim 1, wherein the second section comprises a tapering angle, β, defined as the angle between a longitudinal center axis (L) of the second section and the periphery of a circle circumscribing an outer surface of the second section,
wherein the tapering angle, β, is less than 2 degrees, or
wherein the tapering angle, β, is between 2 and 6 degrees, or
wherein the tapering angle, β, is between 6 degrees and 15 degrees.

5. The lamp or the luminaire according to claim 1, wherein
the second section extends over between 1% and 35% of the total longitudinal extension of the at least one optical fiber, or wherein
the second section extends over between 35% and 65% of the total longitudinal extension of the at least one optical fiber, or wherein
the second section extends over between 65% and 90% of the total longitudinal extension of the at least one optical fiber.

6. The lamp or the luminaire according to claim 1, wherein the cross-sectional area at the second end is less than 50%, less than 25% or less than 10% of the cross-sectional area at the first end.

7. The lamp or the luminaire according to claim 1, wherein one or both of the following applies:
the second end is any one of blunt and pointed, and
the second section is any one of tapered, conical and frustoconical.

8. The lamp or the luminaire according to claim 1 claims, wherein the first section is configured to mix light propagating therethrough.

9. The lamp or the luminaire according to claim 1, wherein the second section is configured to broaden the angular spread of the light propagating therethrough.

10. The lamp or the luminaire according to claim 1, wherein the optical fibers of the array of optical fibers all comprise a cross-section of the same shape, or
wherein at least one optical fiber of the array of optical fibers comprises a cross-section having a first shape, and the remaining optical fibers of the array of optical fibers comprise a cross-section having a second shape being different from the first shape.

11. The lamp or the luminaire according to claim 1, wherein a cross-sectional shape of each optical fiber of the array of optical fibers perpendicular to the longitudinal axis is any one of square, rectangular, octagonal, circular and hexagonal.

12. The lamp or a luminaire according to claim 1, wherein at least one optical fiber of the array of optical fibers further comprises a mirror or a rotatable mirror arranged at the light exit facet.

13. The lamp or the luminaire according to claim 1, wherein the array of optical fibers further comprises a monolithic mirror element arranged at the light exit facets of the optical fibers of the array of optical fibers.

14. The lamp or the luminaire according to claim 1, further comprising a plurality of laser light sources, each being configured to, in operation, emit a beam of laser light, at least two laser light sources of the plurality of laser light source being arranged to emit the respective beams of laser light in a direction towards the first end of the same optical fiber of the plurality of optical fibers.

15. The lamp or the luminaire according to claim 14, wherein the controller is configured for individually controlling each of the plurality of laser light sources.
